(19) United States
(12) Patent Application Publication
(10) Pub. No.: US 2004/0241633 A1
(43) Pub. Date: Dec. 2, 2004

(54) Professor pop-up & method

(76) Inventor: William P. Drozda, Pulaski, VA (US)

Correspondence Address: THE TECHNOLOGY LAW OFFICES OF VIRGINIA, P.O. Box 818, Middleburg, VA, 20118, US

(21) Appl. No.: 10/446,756

(22) Filed: May 28, 2003

(51) Int. Cl. G09B 3/00

(52) U.S. Cl. 434/350

(57) ABSTRACT

A software program for allowing students to gain time on the internet to communicate with their friends thereon by answering questions and problems which “pop-up” over time when they on on-line. The questions and problems are selected by the students parents to reinforce and/or initiate learning by the student in pre-selected areas which include mandatory achievement tests as well as normal course studies. There is included a look up data base for assisting the student when he or she does not know the answer. The student can accumulate earned internet time by answering questions correctly.

This invention relates to a method and program for dealing with what has become problem behavior with young people in elementary, middle or high school. The program is used to motivate students to concentrate, learn and retain school based and test based knowledge while utilizing the internet in a home environment.

### THE PROBLEM

Pre-teens and teens are heavily into use of the internet to carry on a social activity which involves communicating with their friends over the internet in long duration “chat sessions”, most times out of sight of their parents. As there is no detectable sound resonating from the computer parents cannot key on children wasting time in lengthy chat sessions when they are supposed to be doing their homework.

Because of this reason and others, the U.S. Educational system has failed to stem the drop in student achievement scores. This threatens the United States as a future economic power as other countries compete more quickly and efficiently, mainly by instilling the motivation to learn and excel at school in their young people. This is especially true in science and mathematics, the subjects which give us new technologies and progress.

The internet has revolutionized a lot of commerce and some education practices. It continues to redefine how people, particularly the country's youth, communicate and gain information. Electronic messaging in the form of instant messaging, chat rooms and e-mails continues to gain in popularity with adolescents and teens worldwide. In many homes, this method of communication has displaced the telephone as the predominant communication tool for adolescents and teenagers.

As classrooms are full and there is no spare education money in local, state or federal budgets any longer, teachers do not have the time to give the one-on-one attention required for special need students in their classrooms which keep increasing in size.

At home, parents, most working these days, resort to tutors and other outside the school resources to bridge learning gaps in their children. Parents continue to be highly motivated to have their children admitted to universities and colleges which are top-draw. Millions are spent on SAT/ACT preparation courses and competition increases for admittance into prestigious colleges.

The increase in electronic communication media, both TV and internet, is consuming time previously devoted to study. Instant messaging, e-mails, music downloads and chat rooms are new adversaries of parents trying to force effective time management skills into their students.

Numerous students have little incentive to concentrate and advance their learning. They have become total social beings with more pressing social priorities. As pressure to perform academically increases, the internet provides distractions and an undesirable alternative to time needed for focused, at-home, learning.

### GENERAL DESCRIPTION

This invention allows for parents to select various options in how pre-selected and targeted questions are delivered electronically to their children as a condition of utilizing the internet in the home environment. One option, entitled “pop-up” question option would allow for pop-up questions and problems to appear on the screen of a student who is communicating with their friends from a home environment. The student logs onto their e-mail account and checks messages. The various IM user groups are made aware of the students presence on-line and the instant messages start flying fast and furious. Soon, more students are on-line communicating. Allowed to go on without any intervention, this dialogue could exceed an hour or even two hours.

The invention provides, after a parentally preset amount of time from being on-line, a notification to the students friends that the student will be temporarily off-line solving a problem. Simultaneously, the student is faced with a parental pop-up question or problem to solve in a given area of academics. If the student answers the question correctly or solves the problem correctly, it is obvious that the student has studied and retained the knowledge, and the internet-based communication with the students friends again commences. That is, the student is back on-line. The sequence can be repeated and the timing is preset by the parent inputting to a customized profile page and is correlated to the students performance in answering questions, solving problems and more general directed at known learning areas of the student. If the student types in the correct answer communication with the friends is restored.

If the student does not know the correct answer or solution, the student presses a help button and has access to a data-base which has an explanation of the problem which will ultimately allow for the correct answer or solution. It takes longer to work through the help screen explanation or answer so that more time is spent away from communicating socially. Thus there is a strong motivation for students to retain knowledge from help screens. They know that the invention will track individual student performance and thus allow for increased frequency of pop-up problems focused at what they don't know versus knowledge they have mastered. To the extent they provide the right answer quickly, their time spent on the internet communicating with friends will increase.

At the conclusion of each week, the parent enters a pass code into the web page of the program and is informed, in real time, of the progress of the student. This personalized assessment tool tells the parent what areas of academics and what subcategory of it the student is having trouble with. Thus, the parent can input into the student's profile data base to increase the frequency of problems and questions that pertain to the academic areas deemed weakest as to proficiency. Once the student has improved the performance in this weak area the parent can check other areas and either reward the student with unimpeded time communicating or check other areas of academics to see if the student has retained what he or she learned in school. Obviously, if the student is failing to answer without going to the data-base, all internet time can be curtailed until the student's performance improves.

The old carrot and stick philosophy is applied. Yet another parental option of the invention is the timing and method of presenting problems to the student. The invention will allow parents to determine how many questions or problems a student should answer as a condition of earning internet time. Using the invention's profile page, which is unique to each student, the parent will have the option of determining for one hour, or one day or one week of uninterrupted internet time, a certain number of problems must be answered correctly, or, attempted by the student. For example, the parent can determine that attempting ten geometry problems and answering them correctly earns one hundred minutes of uninterrupted internet time. Assuming this option to be selected by the parent, the program will allow the student to “bank” a certain number of internet minutes upon successful completion of a quantity of problems as selected by the parent.

### BACKGROUND ART

The problems sought to be over come by the instant invention have never been addressed by the prior art.

### OBJECTS OF THE INVENTION

Accordingly, it is an object of this invention that the internet usage by a student at home can be used to test the students knowledge in a given area and to reinforce that retained learning by the student,

It is another object of this invention to provide a system for customization of pop-up problems based on the students age and school grades as well as specific learning needs and objectives, and

It is still another object of this invention to provide an incentive to a student to concentrate and retain knowledge, and

Still further, it is an object of this invention to provide learning via an electronic platform,

It is yet another object of this invention to use the motivation of maintaining electronic communication as a reward for learning to address solutions to problems and to retain that knowledge.

These and other objects will become apparent when reference is had to the accompanying specification and drawing

### DETAILED DESCRIPTION

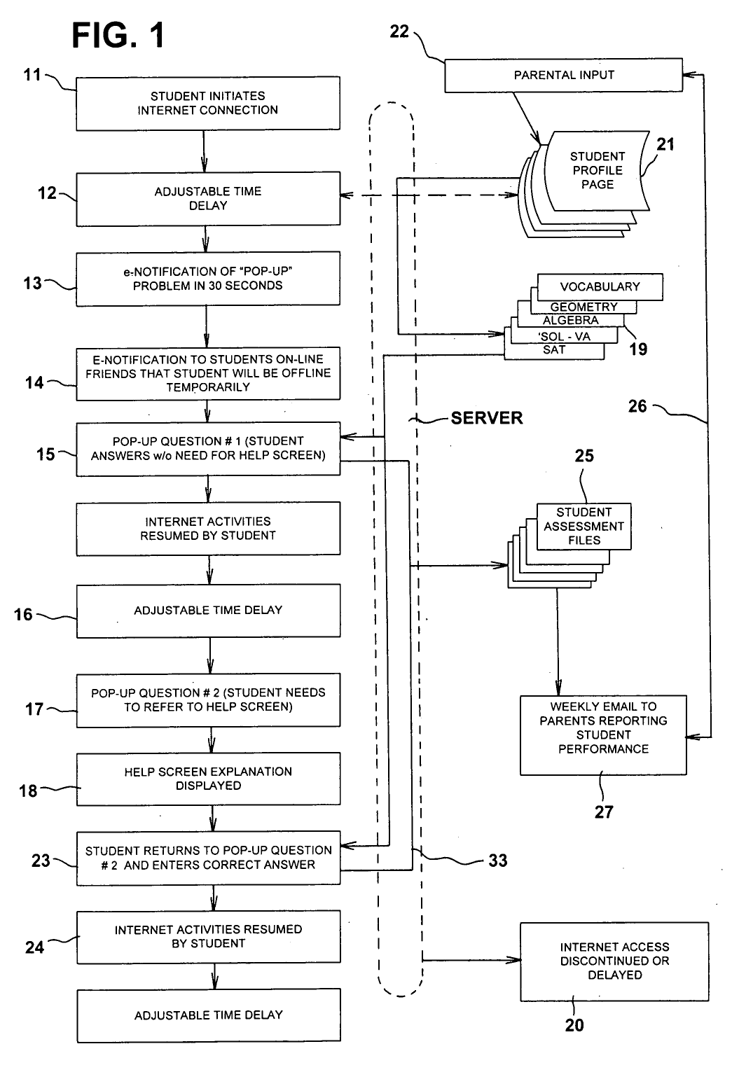

FIG. 1 is a schematic chart of the sequence of events involved in the method of this invention.

Referring to FIG. 1 there is shown the overall system 10. As shown at 11a student logs into their e-mail account thus prompting various IM user groups to be aware that the student is on-line and the instant messages commence.

Approximately 15 minutes after being on-line, a message “pops-up” using the software herein notifying the student that a problem will be forthcoming in approximately 30 seconds as in 13.

In 14, the student's on-line friends are sent an electronic pop-up message indicating that the student's electronic activities will be temporarily interrupted while the student works a problem.

The student gets a geometry problem electronically transmitted to their computer via a pop-up screen as in 15. The student gets the problem solved quickly and after typing in the correct answer and having it acknowledged by the software, the student is back on-line communicating with her friends. The time from when the student first gets on-line and when a problem appears is regulated by the time delay 12 which can be adjusted by the student's parents 22 on the Student Profile Page as in 21.

After another 15 minutes which can be adjusted at 16 by parents via 22, the student is notified of another problem forthcoming in 30 seconds. Once again, the student's on-line friends are also notified electronically by the software. The second problem, as at 17, confounds the student and she is forced to seek help in arriving at the solution by clicking the Help button as in 18, thus displaying the Help screen with data electronically transferred from Data File 19. If the student cannot answer the question with the help of the Help Screen information provided, internet access can be shutdown as in 20 if selected as an option by parents 22 in Students Profile Page as in 21,

It should be noted that this program does not encourage guessing since not providing the correct answer can eventually shut down internet access or cause a predetermined delay thus shutting down or delaying the student's communications with friends. Through transmittal of data via database information at 19, the student enters the correct information to solve the problem as in 23, and is immediately resumed in accessing the internet communicating with friends as in 24. By concentrating and absorbing the information contained on Help screens, the student will minimize the number of times Help screens are accessed thus increasing the amount of time they spend on-line with their friends.

The information that tracks student performance is maintained in individualized data files at 25. This information an be accessed by parents with passwords at any time via 26. Additionally, the student's performance will be e-mailed to the parents e-mail address via 27.

Entering the correct answer for problems that are known and wherein the Help screen is not accessed is estimated to take between 30 and 45 seconds. Utilizing the Help screen will extend the time being off-line to 3 to 5 minutes. Thus, it is seen that there is a strong motivation to learn the concept and to retain the knowledge.

As in 26, the parent can access the student's records at anytime to see an assessment of the student's performance for a selected period of time. This same information will be e-mailed to the parent's account weekly as in 27. The assessment will include information on number and types of problems attempted, as well as number and types of problems answered correctly without the use of the Help screen. This information will allow the parent to determine what type of problems should continue to pop-up as the student has not mastered this knowledge. Or, in the alternative, what types of problems the student is answering correctly thus indicating a mastery of that learning concept. With this information, the parents can adjust the types of problem presented via 22 by changing certain selections in fields on the Student's Profile page as at 21.

Additionally, if the parent desires to deactivate the software, as at 22, for a time period, or, perhaps, to decrease the time interval that problems are submitted from 15 minutes to 10 minute intervals, parents can change the selection field within 21.

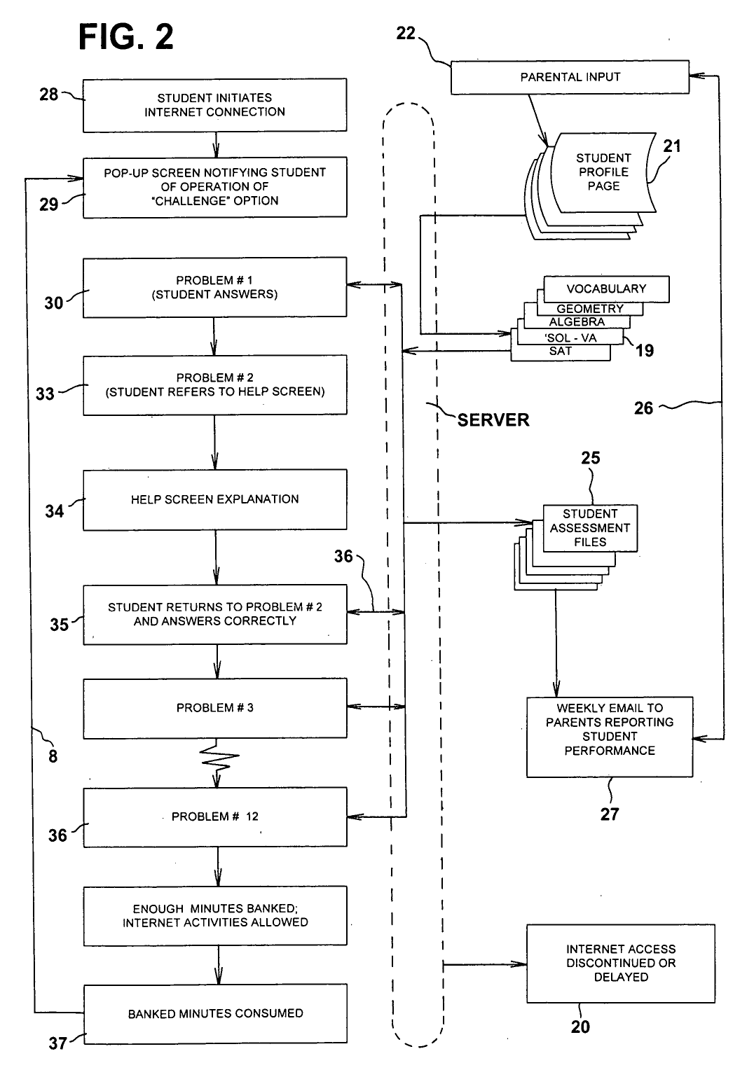

FIG. 2 is a schematic chart of the sequence of events involved in the challenge question option on this invention. This schematic outlines sequential events when parents opt to utilize the challenge option as a means for having students answer problems and thus earn internet time.

As at 22, the parent will select the problem delivery method best suited for the individual circumstances of the student. In this case the parents determine that for every problems correctly answered, 10 minutes of internet time can be “banked” by the student.

As in 28, the student initiates an internet connection. Once this connection is achieved, the program, as in 29, will explain to the student the conditions of earning Internet time that can be banked. These conditions are determined by the parents as an input via 22. At 29, the student knows that for every problem answered correctly, 10 minutes of internet time is earned and banked. Thus, if the student assumes, for example, that they want to spend two hours on the internet, twelve problems as in 19 and as selected by the parents in 22 via data stored at 21 will need to be answered correctly.

In 30, the student is presented with the first problem and the answer is known and entered. The program identified the correct answer and as in 31, ten minutes is recorded via the program server at 32 and recorded in the student's assessment file 25.

In 33, the student is presented with the second problem. In this case, the student must access the Help screen at 34, for an explanation related to solving the problem. After reviewing information on the Help screen the student returns to the problem with the knowledge to solve the problem.

In 35, the student enters the correct answer. Again, the program server at 32 records the correct answer and awards the student an additional ten minutes to the bank of internet time at 36.

As the student's objective was to bank 120 minutes of internet time, once the correct answer to the twelfth problem is entered as in 36, the program will notify the student of the level of internet minutes currently in their bank. At this point, the student is further notified and congratulated that they have successfully achieved their goal and that they may commence their on-line services.

As at 37, assuming that the student is online for a time in excess of their banked minutes, the program will notify the student automatically that they must begin answering more problems via 38. If the student chooses not to answer and thus bank additional minutes, the student's on-line connection is discontinued as in 20.

The parent, armed with knowledge from the student assessment screen, or, of circumstances the compel a change in program form can initiate the following changes by inputting data onto the student profile page.

1. Reduce the frequency of problems in an area where the student is doing well but where she still needs reinforcement to retain her newly acquired knowledge.

2. Deactivate the program over the weekend or at any time as a reward for good achievement.

3. If the student is going to take a test or a SOL test, the parent selects sample test questions from the prior SOL tests and pop-up problems for the week before the test. By calculating how much time the student is on the internet, the parent can calculate how many sample tests she can be exposed to prior to the actual test. If more intense exposure is needed, the time between questions can be decreased from 15 to 10 or even 5 minutes.

4. Select the method by which problems will be presented to the student. Either pop-up problems or the challenge method wherein problems are solved and time is banked can be selected.

5. If the challenge method is selected, the amount of internet time that each successfully answered problem is worth can be determined by the parent.

The types of problems that can be accommodated by the program include mathematics (geometry, fractions, algebra, trigonometry, basic addition and subtraction) language and grammar (vocabulary, word association, grammar, punctuation, and reading comprehension and retention) as well as SAT and ACT tests and foreign languages.

While only one embodiment of the invention has been shown and described, it will be obvious to those of ordinary skill in the art that many changes and modifications can be made without departing from the scope of the appended claims.

1. A program to motivate students and to retain school-based knowledge while utilizing the internet at home, said program comprising
a. means for the student to communicate via the internet for a period of time with his or her friends,
b. means to provide pop-up questions and/or problems for the student during the period he or she is communicating with friends on the internet,
c. means to allow the student to continue communicating with his or her friends via the internet by successfully answering the pop-up question and/or solving the pop-up problem,
d. means to terminate the communication of the student via the internet if the student does not correctly answer the question or solve the problem.

2. A program as in claim 1 wherein the type and difficulty level of the pop-up problems and/or questions are selected by the students parent or legal guardian.

3. A program as in claim 1 including a look-up help data base where the student may access an explanation of the problem's solution prior to answering the question or solving the problem.

4. A program as in claim 3 wherein the program provides notice to the students friends via the internet that she or he will be delayed in communicating while he or she answers a question or solves a problem.

5. A program as in claim 1 wherein there are a series of pop-up problems and/or questions and the student must address each one.

6. A program as in claim 5 wherein there are adjustable delays between the pop-up questions and/or problems which are adjustable by either the data base or directly by the students parent.

7. A program as in claims 3 and 5 wherein the more the student accesses the look up date base to find the correct answer and/or solution, the smaller the time delay between pop-up questions and/or problems.

8. A program as in claim 7 where each use of the look up data base by the student is registered in the look up data base for employment in adjusting the time delay between pop-ups and/or the amount and/or frequency of questions and/or problems in a particular academic area where a learning deficiency may exist.

9. A program as in claim 1 wherein the parent is provided with a periodic update of the progress of the student in answering the questions and solving the problems with and without the look up data base.

10. A program as in claim 9 wherein the parent is notified via e-mail of the student performance thus allowing changes in student's profile page.

11. A program as in claim 1 wherein the questions and/or problems, as well as the look up data base can be tailored for various academic subjects.

12. A program as in claim 11 wherein a parent may increase the type of question and/or problem a student confronts depending on the subject the student is having difficulty with.

13. A program as in claim 11 wherein the subject is math.

14. A program as in claim 11 wherein the subject is vocabulary and word association.

15. A program as in claim 11 wherein the subject is geometry.

16. A program as in claim 11 wherein the subject is algebra.

17. A program as in claim 11 wherein the subject is grammar.

18. A program as in claim 11 wherein the subject is languages.

19. A program as in claim 11 wherein the subject is geography.

20. A method of motivating students to retain school based knowledge while utilizing the internet at home, said program comprising
a. providing an academic look up data base with both questions and problems as well as the answers and solutions, respectively, thereto,
b. interrupting the student's communication on the internet with a series of timed questions and/or problems that he or she must answer before being allowed to continuing to communicate,
c. allowing said student to continue communicating on the internet after the student answers the question or solves the problem correctly,
d. providing access to the correct answer and/or solution in the look up data base if the student does not know the answer and or solution.

21. A method as in claim 20 wherein the method includes allowing the parent of the student to program the type and frequency of questions the student encounters during his or her time on the internet depending on the number of times the student has to access the look up data base to successfully answer a question or to solve a problem.

22. A method as in claim 21 wherein the parent may also vary the time between questions and/or problems.

23. A method as in claim 22 wherein the party a student is communicating with is notified of a delay when a pop-up question or problems is presented to the student.

24. A method as in claim 21 wherein the results of the students performance in answering questions and solving problems successfully without accessing the look up data base is periodically transmitted to the parent by e-mail.

25. A method as in claim 20 where the student must first answer a question or solve a problem correctly prior to being connected to the internet.

26. A method as in claim 20 wherein the student can earn internet time by correctly answering problems.

27. A method as in claim 26 wherein students can build a bank of internet minutes by successfully answering questions.

28. A method as in claim 27 wherein a parent can determine the value, expressed in earned and banked internet minutes, for each successfully answered problem.

29. A method as in claim 26 wherein students can utilize the internet uninterrupted by using earned and banked minutes.

30. A program as in claim 11 wherein the subject is SAT questions and/or problems.

31. A program as in claim 11 wherein the subject is a state SOL test.

32. A program as in claim 1 wherein the subject is advanced placement tests.
